(19) United States
(12) Patent Application Publication
(10) Pub. No.: US 2019/0060035 A1
(43) Pub. Date: Feb. 28, 2019

(54) METHOD FOR PRODUCING A SINGLE-TOOTH REPLACEMENT STRUCTURE USING A 3D PRINTER, 3D PRINTER FOR PRODUCING A SINGLE-TOOTH REPLACEMENT STRUCTURE, AND SINGLE-TOOTH REPLACEMENT STRUCTURE

(71) Applicant: COLTÈNE/WHALEDENT AG, Altstatten (CH)

(72) Inventor: Martin SCHAUFELBERGER, Weesen (CH)

(21) Appl. No.: 16/050,300

(22) Filed: Jul. 31, 2018

(30) Foreign Application Priority Data
Aug. 23, 2017 (EP) 17187393.8

(51) Int. Cl. A61C 13/00; A61C 8/00; A61C 13/08

(52) U.S. Cl. CPC A61C 13/0013; A61C 8/0036; B33Y 10/00; A61C 13/081; A61C 13/0018

(57) ABSTRACT

The present invention relates to a method for producing a single-tooth replacement structure (50) or a single-tooth replacement structure (50) with a substructure (51) using a 3D printer (10) comprising at least a first applicator (A1) and a carrier (T). The method comprises the following steps: i. placing a substructure (51) on the carrier (T); ii. applying material, in particular applying a composite material (K), to the substructure (51) by means of the first applicator (A1) from a first direction (r₁) relative to the substructure (51); iii. rotating the substructure (51) placed on the carrier (T) about a first axis of rotation (a) through a first angle (α) relative to the first applicator (A1); iv. applying material, in particular applying a composite material, to the substructure (51) by means of the first applicator (A1) from a second direction (r₂) relative to the substructure (51); v. optionally: iteratively repeating steps iii and iv. The single-tooth replacement structure (50) is produced by means of this method. The invention also comprises a 3D printer (10) for producing a single-tooth replacement structure (50) or a single-tooth replacement structure (50) with a substructure (51), and a single-tooth replacement structure (50) or single-tooth replacement structure (50) with a substructure (51) which can be produced using said 3D printer.

The present invention relates to methods for producing a single-tooth replacement structure using a 3D printer, a 3D printer for producing a single-tooth replacement structure, and single-tooth replacement structures.

Dental replacement structures, in particular single-tooth replacement structures, are generally complex moulded parts. A “single-tooth replacement structure” is understood here and hereinafter to mean a tooth replacement structure which is intended and suitable for the replacement of just one individual tooth. For example, a single-tooth replacement structure can be an individual tooth crown, which can be connected to an abutment for an implant. The abutment for example can be fastened to an implant screw on the jawbone.

When producing replacement structures, the spatial configuration of preserved tooth parts, adjacent and/or antagonist teeth, and of the affected jaw must be taken into consideration individually. The original shape of the teeth which are to be replaced wholly or partially and aesthetic aspects also should not be left out of consideration. In order to produce replacement structures of this kind, multi-step moulding and casting methods are primarily used nowadays. These methods have indeed proven their worth in practice, and are associated with a high manufacturing outlay. Accordingly, a series of methods have been developed more recently in order to reduce this outlay and provide higher quality replacement structures in the field of dentistry.

A main focus has been directed in this respect towards what is known as digital fabrication, in which three-dimensional objects are produced on the basis of computer-generated data. In this context, subtractive manufacturing methods are known on the one hand, in which a desired moulded part is manufactured from solid material by data-controlled milling. However, this leads inevitably to a significant material consumption. In addition, the accrued waste must then be disposed of or reprocessed, which is laborious.

Additive fabrication methods, however, have also been developed, in which a moulded part is constructed from one or more base materials. A particular position is occupied in this context by what is known as 3D printing. 3D printers have the advantage that they only use as much material as is actually required. This offers a significant advantage in particular when producing moulded parts in small numbers, as is generally the case when manufacturing dental replacement structures.

3D printing generally denotes all production methods which construct a component part by joining material portions to one another layer by layer. Nowadays, many different 3D printing methods are known. Some methods use light or laser in order to solidify geometric structures made of photosensitive resin. For example, these methods include stereolithography (STL) or direct light processing (DLP).

The use of print heads as are used similarly in conventional inkjet printing is known. Here, photosensitive and low-viscous liquids are deposited in layers in the form of droplets and are cured by means of irradiation. For example, depending on the equipment of the manufacturer, the methods are referred to as multi jet modelling (MJM) or polyjet printing (PJP).

In a modification thereof, a photosensitive liquid (ink, binder) can be sprayed into a powder bed in order to selectively bind powder particles and connect them in layers to form a component part. An example of this is what is known as color-jet printing (CJP). Either the binder itself is coloured, or binder and colour pigments are deposited by means of different nozzles. In other methods a viscous liquid is extruded in the form of a strand, and this is deposited in layers on a construction platform. The used material can be molten polymer-based material or a paste formed of a liquid/resin-solids mixture. When using thermoplastics, the component part can be cured by phase transition (solidification), or, when using resin systems, by irradiation with photoinitiators. Examples are fused deposition modelling (FTM) or 3D plotting.

The surface roughness can be very different as a result of the layering, depending on the method used. Most methods require a post-treatment, for example the removal of auxiliary material/support material. Depending on the quality of the auxiliary material, this can be implemented by melting, mechanical breaking or radiation or by dissolution in a bath.

Other possible post-treatments, in the case of photosensitive resins, are a post-curing with light and/or heat, resin infusion for closing pores, or lacquering.

For dental applications, various methods are already currently used, for example SLM for metal frameworks of removable prostheses, MJM for models and drill templates, and STL for temporary solutions.

The production of single-tooth replacement structures, however, remains difficult in many situations, for example when a composite material from which a single-tooth replacement structure such as an individual tooth crown is to be formed has to be applied to an abutment serving as substructure. Specifically, it is then insufficient to apply the composite material around an outer periphery of the abutment. Rather, the composite material must also protrude at least partially beyond the abutment in the direction of a longitudinal axis of the abutment. In the known methods, the material must therefore be applied to the abutment from different directions, inter alia from a horizontal direction. Since the force of gravity, however, then deflects the material dispensed from a nozzle of an applicator from a straight path, this application is very imprecise. In the case of materials having relatively high viscosities, application from a horizontal direction can also be problematic.

The object of the present invention is therefore to overcome the disadvantages of the prior art. In particular, a method for producing a single-tooth replacement structure is to be provided, in which the applied material, in particular a material having a relatively high viscosity, can be applied in a precise manner from a plurality of directions with respect to a substructure, in particular an abutment.

This object is achieved on the one hand by a method for producing a single-tooth replacement structure or a single-tooth replacement structure with a substructure using a 3D printer comprising at least a first applicator and a carrier. The method in accordance with the invention comprises the following steps:
i. placing a substructure on the carrier;
ii. applying material, in particular applying a composite material, to the substructure by means of the first applicator from a first direction relative to the substructure;
iii. rotating the substructure placed on the carrier about a first axis of rotation through a first angle relative to the first applicator;
iv. applying material, in particular applying a composite material, to the substructure by means of the first applicator from a second direction relative to the substructure;
v. optionally: iteratively repeating steps iii and iv.

The method is carried out in such a way that the single-tooth replacement structure is produced.

The applied and optionally then cured material forms a single-tooth replacement structure. As already explained above, the substructure can be formed for example by an abutment for an implant, and the material applied thereto can be provided in order to form an individual tooth crown, which forms the single-tooth replacement structure.

This sequence of method steps according to the invention makes it possible, in a simple way, to apply material from two different directions relative to the substructure, specifically in step ii from a first direction relative to the substructure and later in step iv from a second direction relative to the substructure. Thus, the first applicator does not necessarily have to be pivoted in order to apply material from two different directions relative to the substructure; instead, it is sufficient if in step iii the carrier rotates together with the substructure placed thereon. Of course, the second direction relative to the substructure is preferably different from the first direction relative to the substructure. It is possible that the first direction and the second direction are coincident relative to a fixed reference system, for example relative to a housing of a 3D printer. In particular, as explained in greater detail further below, the first direction and the second direction in a fixed reference system can both be oriented in the direction of the force of gravity. In this way, a precise material application, in particular of a material having a relatively high viscosity, from different directions relative to the substructure is significantly simplified.

In order to satisfy the necessary strength and rigidity required in order to take up the chewing forces that occur, and for sufficient abrasion resistance and for a reasonable service life of the single-tooth replacement structure, it is preferred if the applied material is a composite material. As disclosed in international patent application PCT/EP2016/054750, the composite material can contain a curable, in particular light-curable matrix and fillers, which preferably have a maximum particle size of 5 μm. The dental composite material in the non-cured state can have a viscosity in the range of from 1 to 10,000 Pa·s, preferably from 10 to 2000 Pa*s, particularly preferably 50 to 800 Pa*s. In this way, a clogging of a nozzle of the first applicator is eliminated to the greatest possible extent, which in particular enables continuous 3D printing. The composite material alternatively or additionally can have one or more of the properties disclosed in the above-mentioned international patent application PCT/EP2016/054750; and/or it can be produced by one of the methods disclosed there; and/or it can be dispensed from a cartridge disclosed there.

Steps ii to iv, in particular steps ii to v, are advantageously carried out continuously. This allows a quick and uniform material application. For example, the carrier can rotate continuously about the first axis of rotation. Steps ii and iii and/or steps iii and iv can advantageously also be performed simultaneously at least in part. For example, the carrier can rotate continuously about the first axis of rotation, and at the same time the material can be applied to the substructure.

Before step ii, the method can additionally comprise the following step:
ia. applying a connection layer to the substructure and/or conditioning the substructure.

For example, the connection layer can be an adhesion promoter, which facilitates the adhesion between substructure and applied material. The adhesion promoter for example can be provided with features conducive to polymerisation. It can contain monomers, which on the one hand can bind via reactive groups to the surface of the substructure and/or to the applied material and which on the other hand have polymerisable groups, which enable copolymerisation with further monomers. The polymerisable groups can be co-polymerised at a later moment in time with the substructure and/or the applied material by suitable methods. In this way, a permanent bond can be created between substructure and applied material, which bond is characterised by covalent or ionic bonds. For example, the product “OneCoat 7 Universal”, obtainable from the applicant Coltène/Whaledent AG, CH-9450 Altstätten, and which is suitable, amongst other things, for abutments made of titanium and also those made of zirconium oxide, can be used as adhesion promoter. A conditioning, for example by plasma treatment or roughening, can also serve to provide increased adhesion between substructure and applied material. For example, a roughening can be achieved by grinding, for example using an emery cloth, or by sandblasting, for which purpose abrasive particles made of corundum can be used, for example.

The first axis of rotation is preferably oriented at right angles to the first direction of the material application. This enables a material application in a peripheral direction relative to the first axis of rotation. The first axis of rotation is preferably oriented horizontally. Specifically, the material can then be applied in the direction of the force of gravity, which leads to a particularly precise application, in particular if a material having a relatively high viscosity is applied.

In some embodiments the method can also comprise the following steps:
vi. rotating the substructure placed on the carrier about a second axis of rotation through a second angle relative to the first applicator;
vii. applying material, in particular applying a composite material, to the substructure using the first applicator from a third direction relative to the substructure.

In particular if the second axis of rotation is different from the first axis of rotation, further directions relative to the substructure can be achieved as a result, in particular directions relative to the substructure that lie outside a plane spanned by the first direction and the second direction. This again significantly extends the range of the directions relative to the substructure in which material can be applied, more specifically when the first applicator is not pivoted.

For this purpose, it is preferred if the second axis of rotation is oriented at right angles to the first axis of rotation and if in particular the second angle of rotation about the second axis of rotation is 90°. This orientation also allows a simple design and a relatively simple determination of coordinates used to carry out the method and also for prior programming of a 3D printer.

The second axis of rotation is particularly preferably oriented vertically. This is because if the first axis of rotation is additionally oriented horizontally, material can initially be applied at an outer periphery of the substructure in the direction of the force of gravity, and then a rotation can occur about the second axis of rotation by 90°, and further material can then be applied to an upper side of the substructure and/or to an upper side of the already applied material, perpendicularly to the outer periphery, more specifically again in the direction of the force of gravity.

If, for example, the single-tooth replacement structure is a single-tooth crown and the substructure is an abutment, it can be advantageous if material is applied only to part of the upper side of the substructure. In particular, an access channel along a longitudinal axis of an abutment can be left free, through which channel an implant screw can be guided during the subsequent implantation. Alternatively, an access channel of this kind can be formed in the single-tooth replacement structure following the application of the material, for example can be milled into said single-tooth replacement structure. In both variants, the access channel can be filled following the implantation.

The carrier with the substructure can optionally also rotate in step vii about an axis of rotation. Alternatively or additionally, the applicator A1 can be moved in step vii.

Alternatively to the rotation of the substructure placed on the carrier about a second axis of rotation through a second angle relative to the first applicator, the method can also comprise the following step:
vi. applying material, in particular applying a composite material, to the substructure using a second applicator from a third direction relative to the substructure.

Due to the second applicator, it is thus possible to dispense with a second axis of rotation, yet it is still possible to apply material from a third direction relative to the substructure. With appropriate orientation, the third direction relative to the substructure can be different from the first direction relative to the substructure and the second direction relative to the substructure. In particular, the third direction of material application can be oriented at right angles to the first direction and the second direction. This specifically for example makes it possible to apply material to an outer periphery of a substructure with the aid of the first applicator and then to apply material to the upper side of the substructure and/or to an upper side of the already applied material with the aid of the second applicator. In some embodiments in which a second axis of rotation is omitted, application can be performed from a non-vertical direction, in particular from a horizontal direction. This, however, can be accepted for example if a material having a relatively low viscosity is applied, for example by spraying.

For the reasons already mentioned above, it is advantageous if the first, the second, and the third direction of the material application are oriented in the direction of the force of gravity, because precise material application is thus significantly simplified, in particular in the case of a material having a relatively high viscosity.

The material applied using the first and/or (if provided) the second applicator can be cured for example in a manner known per se using a focused light beam and/or a laser beam. Precise curing and thus shaping can be provided as a result.

It is particularly advantageous if an interlocking connection between the substructure and the single-tooth replacement structure, i.e. for example between an abutment and an individual tooth crown produced from a composite material, is created by at least one undercut. Specifically, dental replacement structures produced by conventional methods are generally pushed onto the substructure and glued. To this end, the substructure for example must be conical in order to enable the dental replacement structure to be fitted over. The omission of the requirement of conicity ensures additional freedom when designing dental single-tooth replacement structures.

The substructure can be selected from the group consisting of dental framework structures, in particular from skeleton structures for bridges or bars, abutments for implants or seccondary parts; metallic or ceramic workpieces; or dental super-structures with ceramic, in particular milled or cast crowns.

In the method according to the invention, different materials can be applied one after the other using the at least one applicator. For example, a first material can be applied firstly using an applicator, and a second material can be applied later using the same applicator. Alternatively, a first material can be applied using a first applicator, and a second material can be applied using a second applicator. The first and the second material for example can differ from one another in respect of their hardness in the cured state and/or their optical properties in the cured state, such as their colour and/or transparency. For example, a first material can be used within the single-tooth replacement structure in order to imitate dentine, and a second material can be used at the surface of the single-tooth replacement structure in order to imitate enamel.

A further aspect of the invention relates to a 3D printer for producing a single-tooth replacement structure or a single-tooth replacement structure with a substructure using a method as described above. The 3D printer comprises at least a first applicator and carrier. In accordance with the invention the 3D printer contains means for rotating the carrier about a first axis of rotation relative to the first applicator. The above-described method can thus be carried out using a 3D printer of this kind, and the above-explained advantages can also be achieved.

For some of the above-described embodiments of the method, it is advantageous if the 3D printer has means for rotating the carrier about a second axis of rotation relative to the first applicator, wherein the second axis of rotation is preferably oriented at right angles to the first axis of rotation. The advantages already explained above can thus also be attained.

The means for rotating the carrier about the first and/or second axis of rotation are preferably selected from servomotors and stepper motors. With motors of this kind, the rotation of the carrier can be controlled particularly precisely.

A further aspect of the invention relates to a single-tooth replacement structure or single-tooth replacement structure with a substructure, which can be produced in accordance with the method according to the invention.

The invention will be explained in greater detail hereinafter on the basis of exemplary embodiments and drawings, although these are not intended to limit the subject matter of the invention. The drawings show, in each case in schematic depictions,

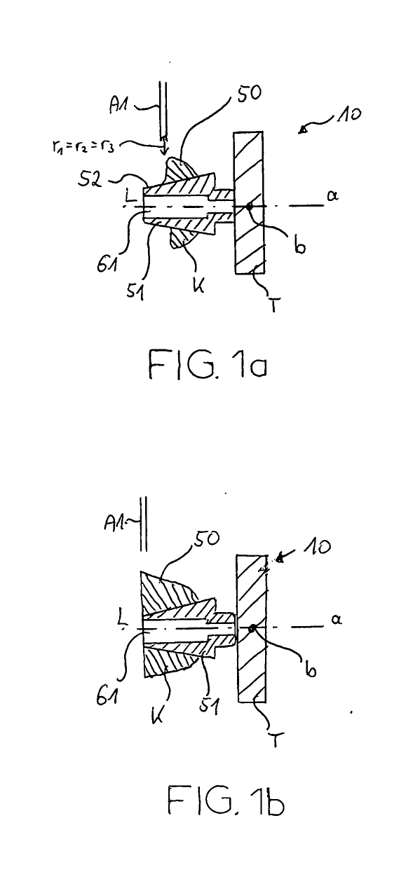

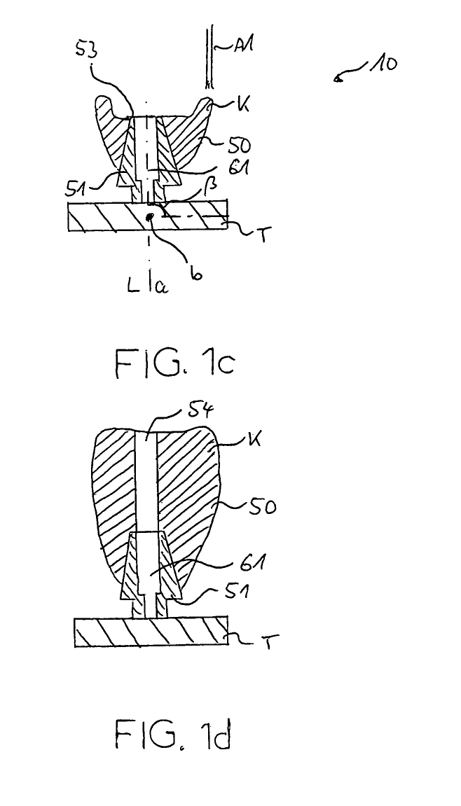

FIG. 1a: in a sectional view, a step of a first method according to the invention, in which a carrier with a substructure is rotated about a first, horizontal axis of rotation and in which a composite material is applied from an applicator to an outer periphery of an abutment;

FIG. 1b: in a sectional view, a moment in time of the first method according to the invention at which the composite material has been applied to an outer periphery of the abutment;

FIG. 1c: in a sectional view, a further step of the first method according to the invention, in which, after a rotation of the carrier with the substructure about a second, vertical axis of rotation, composite material is applied from the applicator to an upper side of the already applied composite material and to an upper side of the abutment;

FIG. 1d: the finished single-tooth replacement structure;

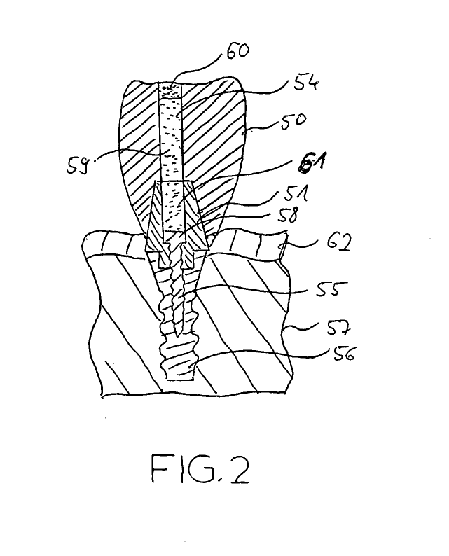

FIG. 2: the implanted single-tooth replacement structure according to FIG. 1d;

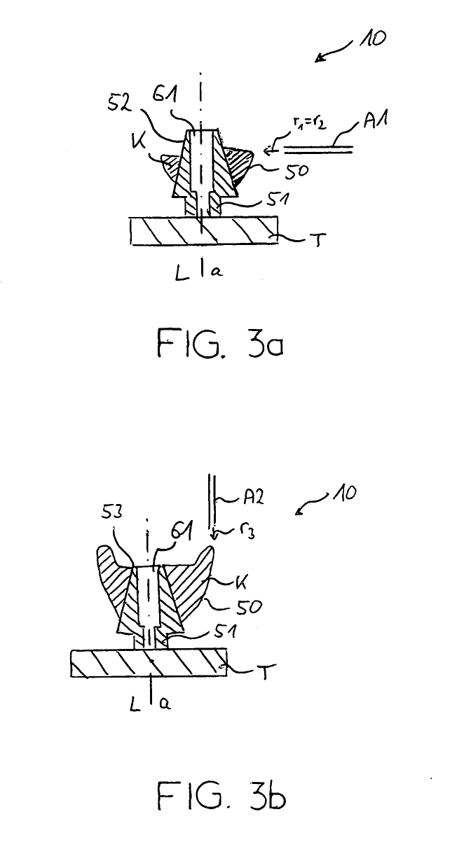

FIG. 3a: in a sectional view, a step of a second method according to the invention, in which a carrier with a substructure is rotated about a first, horizontal axis of rotation and in which a composite material is applied from a first applicator to an outer periphery of an abutment;

FIG. 3b: in a sectional view, a further step of the second method according to the invention, in which composite material from a second applicator is applied to an upper side of the already applied composite material and to an upper side of the abutment.

The 3D printer 10 shown in FIGS. 1a and 1b contains an applicator A1 and a carrier T. The carrier T is rotatable with the aid of a servomotor or stepper motor (not shown here) about a first, horizontally extending axis of rotation a relative to the applicator A1. In a previous first step i, a substructure formed as an abutment 51 was placed on the carrier T. The abutment 51 contains a longitudinal axis L, which in the position shown in FIG. 1a is coincident with the first axis of rotation a, and a screw channel 61 extending along this longitudinal axis L. In an optional step ia, a connection layer can then be applied to the abutment 51 and/or a conditioning of the abutment 51 can be performed. The connection layer can consist for example of the adhesion promoter “One-Coat 7 Universal” already mentioned above.

As shown in FIG. 1a, when steps ii to iv are performed continuously and simultaneously, the abutment 51 placed on the carrier T is then rotated about the first axis of rotation a relative to the applicator A1, and composite material K is applied from the applicator A1 to an outer periphery 52 of the abutment 51. The composite material K for example can have one of the compositions disclosed in PCT/EP2016/054750.

With the rotation about the first axis of rotation a, the material is always applied vertically downwardly, i.e. at right angles to the first axis of rotation a and in the direction of the force of gravity. This enables a particularly precise application, in particular if the material has a relatively high viscosity. Whereas the direction of the material application in a fixed reference system, i.e. for example relative to a housing of the 3D printer 10, remains unchanged, the direction relative to the abutment 51 changes, such that material can be applied around the outer periphery 52. By way of example, two directions r₁ and r₂ are shown, which are identical in the fixed reference system.

The material applied with the applicator A1 is cured by means of a focused light beam and/or a laser beam (not shown here). In this way, a first part of a tooth crown 50 (shown in FIG. 1b), which forms the single-tooth replacement structure, is created.

In a step vi the carrier T is then rotated together with the abutment 51 placed thereon through a second angle β=90° about a second axis of rotation b relative to the applicator A1. This can also be achieved with a servomotor or stepper motor (not shown here). The second axis of rotation b extends perpendicularly to the drawing plane, i.e. horizontally and at a right angle to the first axis of rotation a. In this way, the position shown in FIG. 1c is produced. In this position, in a step vii, there is a further application of the composite material K to an upper side of the already applied composite material K and to part of the upper side 53 of the abutment 51. Here, an access channel 54 is along a longitudinal axis L of the abutment 51 is left free, which access channel is aligned with the screw channel 61 of the abutment 51 and through which an implant screw 55 can be guided. As a result, the composite material K can also protrude beyond the abutment 51 in the direction of the longitudinal axis L of the abutment 51. This application is performed in a third direction r₃, which is coincident in a fixed reference system with the first direction r₁ and the second direction r₂, that is to say likewise in the direction of the force of gravity. In this direction relative to the abutment 51 as well, a more precise material application is ensured. In step vii, the carrier T can likewise rotate together with the abutment 51 about the now vertically oriented axis of rotation a. Alternatively or additionally, the applicator A1 can be moved in step vii.

On the whole, this method produces a single-tooth replacement structure 50, shown in FIG. 1d, in the form of an individual tooth crown, which is connected to the abutment 51.

The single-tooth replacement structure 50 produced by 3D printing can then be polished, for example using composite polishing means and/or abrasive pastes known per se. The subgingival region of the single-tooth replacement structure 50 is preferably also polished, so that this is gentle on the periodontium. The single-tooth replacement structure 50 with the abutment 51 can be fitted onto an implant 56 and secured through the gum 62 to a jawbone 57 by means of a screw, which is guided through the access channel 54 and the screw channel 61. The access channel 54 can be filled with a spacer material 59, for example with cotton pellets or a root canal filler material, such as the product GuttaFlow, obtainable from the Applicant Coltène/Whaldent AG, CH-8450 Altstatten, via the head 58 of the implant screw 55. An upper end of the access channel 54, for example the upper 2 to 3 mm thereof, can then be filled with a light-curing composite 60, such as the product Brilliant EverGlow, also obtainable from the applicant Coltène/Whaldent AG, CH-8450 Altstatten. This then results in the situation shown in FIG. 2.

In the case of the second method according to the invention shown in FIGS. 3a and 3b, a carrier T is now rotated about a single vertical axis of rotation a. In order to compensate for this, two applicators A1, A2 are used, in contrast to the first exemplary embodiment according to the invention. In a first step i, a substructure in the form of an abutment 51 is placed on the carrier T in this case as well. In a step ii a composite material K is applied by means of a first applicator A1 to an outer periphery 52 of the abutment 51 from a first, here horizontal direction r₁ (see FIG. 3a). At the same time, the abutment 51 placed on the carrier T rotates in a step iii about the aforementioned first, vertical axis of rotation a. Here, in a step iv, composite material K is also applied to the outer periphery 52 of the abutment 51, more specifically also in the same horizontal direction (relative to a fixed reference system) r₂=r₁.

In a step vi, material is then applied using a second applicator A2 from a third, vertical direction r₃ relative to the abutment, more specifically is applied to an upper side of the already applied composite material K and to part of the upper side 53 of the abutment 51. During this process the carrier T can still rotate about the horizontal axis of rotation a. Here as well an access channel along a longitudinal axis L of the abutment 51 is left free, which access channel is aligned with the screw channel 61 of the abutment 51 and through which an implant screw 55 can be guided (see FIG. 3b).

With the method according to the invention it is not only possible for a composite material K be applied to an abutment 51 or another substructure. For example, a coating can also be applied, for example to an already cured composite material of a single-tooth replacement structure. For example, a coating can be applied to the single-tooth replacement structure 50 shown in FIG. 1d by means of the method depicted in FIGS. 3a and 3b. If the coating has a sufficiently low viscosity, it can be sprayed on. A material of sufficiently low viscosity can be sprayed on in a precise manner from the horizontal direction r₁.

1-16. (canceled)

17. A method of producing a single-tooth replacement structure or a single-tooth replacement structure with a substructure using a 3D printer comprising at least a first applicator and a carrier, wherein the method comprising:
i. placing a substructure on the carrier;
ii. applying a material to the substructure by the first applicator from a first direction relative to the substructure;
iii. rotating the substructure placed on the carrier about a first axis of rotation through a first angle relative to the first applicator; and
iv, applying a material to the substructure by the first applicator from a second direction relative to the substructure;
in such a way that the single-tooth replacement structure is produced.

18. The method according to claim 17, further comprising carrying out steps ii to iv continuously.

19. The method according to claim 17, wherein, before step ii, the method additionally comprises at least one of the following:
applying a connection layer to the substructure; or conditioning the substructure.

20. The method according to claim 17, further comprising orienting the first axis of rotation at right angles to the first direction of the material application.

21. The method according to claim 17, wherein the method also comprises the following steps:
vi. rotating the substructure placed on the carrier about a second axis of rotation through a second angle relative to the first applicator;
vii. applying material to the substructure using the first applicator from a third direction (r₃) relative to the substructure.

22. The method according to claim 21, further comprising orienting the second axis of rotation at right angles to the first axis of rotation.

23. The method according to claim 17, wherein the method also comprises the following step:
vi, applying material to the substructure using a second applicator from a third direction relative to the substructure.

24. The method according to claim 23, further comprising orienting the third direction of material application at right angles to the first direction and the second direction.

25. The method according to claim 17, further comprising orienting the first and the second direction of material application in a direction of a force of gravity.

26. The method according to claim 17, further comprising using at least one of a focused light beam or a laser beam to cure the material applied using an applicator.

27. The method according to claim 17, further comprising creating an interlocking connection, between the substructure and the single-tooth replacement structure, by at least one undercut.

28. The method according to claim 17, wherein the substructure is selected from a group consisting of dental framework structures; metallic workpieces; ceramic workpieces; or dental superstructures with ceramic crowns.

29. A 3D printer for producing a single-tooth replacement structure or a single-tooth replacement structure with a substructure using a method according to claim 17, comprising at least a first applicator and a carrier, further including means for rotating the carrier about a first axis of rotation relative to the first applicator.

30. The 3D printer according to claim 29, for producing a single-tooth replacement structure or a single-tooth replacement structure with a substructure using a method comprising:
i. placing a substructure on the carrier;
ii. applying a material to the substructure by the first applicator from a first direction relative to the substructure;
iii. rotating the substructure placed on the carrier about a first axis of rotation through a first angle relative to the first applicator; and
iv. applying a material to the substructure by the first applicator from a second direction relative to the substructure;
in such a way that the single-tooth replacement structure is produced;
further comprising means for rotating the carrier about a second axis of rotation relative to the first applicator.

31. The 3D printer according to claim 29, wherein the means for rotating the carrier about the first axis of rotation are selected from servomotors and stepper motors.

32. A single-tooth replacement structure or single-tooth replacement structure with a substructure, which can be produced in accordance with the method according to claim 17.

33. The method according to claim 17, further comprising using a composite material as the material.

34. The method according to claim 22, further comprising using 90° as the second angle of rotation about the second axis of rotation.

35. The method according to claim 25, further comprising orienting the third direction of material application in the direction of a force of gravity.

36. The method according to claim 17, further comprising iteratively repeating steps iii and iv.

37. The 3D printer according to claim 30, further comprising iteratively repeating steps iii and iv.
